(19) United States
(12) Patent Application Publication
(10) Pub. No.: US 2023/0019380 A1
(43) Pub. Date: Jan. 19, 2023

(54) 4G/5G Open RAN CU-UP Pool Solution

(71) Applicant: Parallel Wireless, Inc., Nashua, NH (US)

(72) Inventor: Amit Ghadge, Pune (IN)

(21) Appl. No.: 17/867,633

(22) Filed: Jul. 18, 2022

Related U.S. Application Data
(60) Provisional application No. 63/222,475, filed on Jul. 16, 2021.

(51) Int. Cl. H04W 28/08; H04W 28/02

(52) U.S. Cl. CPC H04W 28/0967; H04W 28/0992; H04W 28/0215

(57) ABSTRACT

A method, system and computer readable media are presented for managing Centralized Unit (CU)-User Plane (UP) in CU-Control Plane (CP). In one embodiment a method includes configuring a pool of CU-UPs; associating a CU-UP of the pool of CU-UPs with a type of subscriber; and selecting a CU-UP of the pool of CU-UPs pool based on characteristics associated with the CU-UP.

### CROSS-REFERENCE TO RELATED APPLICATIONS

This application claims priority under 35 U.S.C. § 119(e) to U.S. Provisional Pat. App. No. 63/222,475, filed Jul. 16, 2021, titled “4G/5G Open RAN CU-UP Pool Solution” which is hereby incorporated by reference in its entirety for all purposes. This application hereby incorporates by reference, for all purposes, each of the following U.S. patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

Open Radio Access Network (RAN) is a movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller).

### SUMMARY

A method, system, and computer readable media is disclosed for GTPC (S11 and S5 interface) Optimization for EPC Core Nodes. In one embodiment a method is disclosed for managing a Centralized Unit (CU)-User Plane (UP) in CU-Control Plane (CP) that includes: configuring a pool of CU-UPs; associating a CU-UP of the pool of CU-UPs with a type of subscriber; and selecting a CU-UP of the pool of CU-UPs pool based on characteristics associated with the CU-UP.

In another embodiment a system managing Centralized Unit (CU)-User Plane (UP) in CU-Control Plane (CP) is disclosed, the system including an Open RAN CU-CP; a configured pool of CU-UPs in communication with the Open RAN CU-CP; wherein the CU-UP of the pool of CU-UPs is associated with a type of subscriber; and wherein a CU-UP of the pool of CU-UPs is selected based on characteristics associated with the CU-UP.

In another embodiment a non-transitory computer-readable medium contains instructions for managing Centralized Unit (CU)-User Plane (UP) in CU-Control Plane (CP), which, when executed, cause the system to perform steps comprising: configuring a pool of CU-UPs; associating a CU-UP of the pool of CU-UPs with a type of subscriber; and selecting a CU-UP of the pool of CU-UPs pool based on characteristics associated with the CU-UP.

### BRIEF DESCRIPTION OF THE DRAWINGS

FIG. 1 is a diagram of an Open RAN architecture, in accordance with some embodiments.

FIG. 2 is a diagram of a CU-CP having a CU-UP connected to it and managed as one single pool, in accordance with some embodiments.

FIG. 3 is a diagram of a CU-Pool based solution architecture, in accordance with some embodiments.

FIG. 4 is a schematic network architecture diagram for 3G and other-G prior art networks.

FIG. 5 is an enhanced eNodeB for performing the methods described herein, in accordance with some embodiments.

FIG. 6 is a coordinating server for providing services and performing methods as described herein, in accordance with some embodiments.

### DETAILED DESCRIPTION

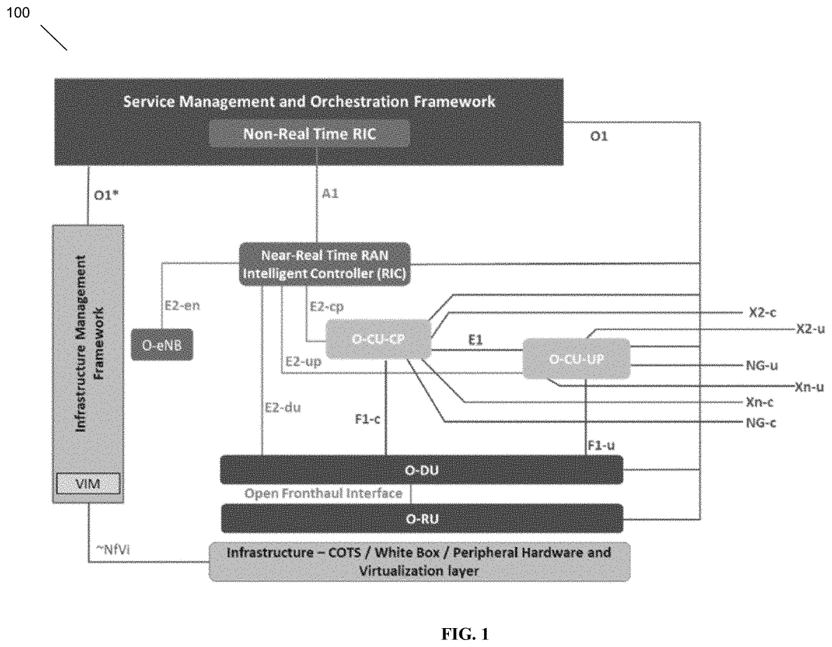

FIG. 1 shows Open RAN architecture 100. as defined by ORAN alliance. The CU function is split into CU-CP (Control Plane) and CU-UP (User Plane) function to provide Control and User Plane separation. An Open RAN compliant solution may support: open interfaces between different functions; software based functions; cloud native functions; intelligence support via support for xApps/rApps; 3rd party RRHs; disaggregated functions; white box COTS hardware support; and data path separated from control plane traffic. Each of these features may be provided by embodiments of the present disclosure, as well.

Control and User plane separation has following advantages: Separation helps in having separate Data centers tailored to function needs; and Data traffic traverses User Plane Path from RU->DU->CU-UP->Core.

CU-CP function handles the control plane traffic and CU-UP function handles the user plane data traffic. CU-UP function has following advantages: Aggregates User Plane traffic from several DU's and abstract number of S1-U/N3 peers from Core; Any DU changes due to handover are masked from the Core; and Helps keep DU unaware of Core details. S1-AP/N2 (for CU-CP control plane) and S1-U/N3 (for CU-UP user plane) interfaces are used between the RAN and the core, with E1 interfaces between CU-CP and CU-UP. An E2 interface exists between CU-CP and RIC. An F1-C interface exists between CU-CP and DU. An F1-U interface exists between CU-UP and the DU (including in the case of multiple CU-UPs, with reference to subsequent figures).

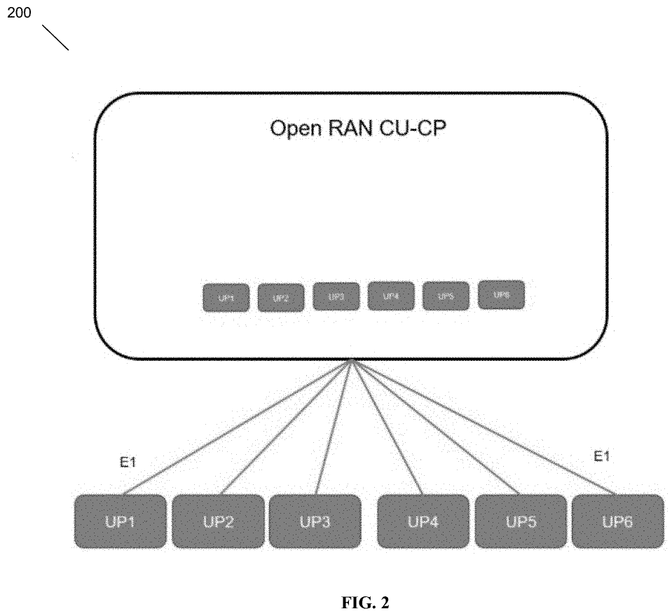

FIG. 2 depicts a system 200 wherein the CU-CP will have CU-UP connected to it and managed as one single pool. Normally multiple CU-UPs will be controlled by CU-CP and all of them will be treated or viewed in similar way. CU-CP uses an E1 interface to control the CU-UP, including in the case that a plurality of CU-UPs are controlled.

Notably, with 4G & 5G there is a desire to support Control and User Plane separation in OpenRAN. There are several benefits of Control and User Plane separation as mentioned above.

With Control (CU-CP) and User Plane (CU-UP) separation of CU, managing 100s-1000s of CU-UP by a CU-CP can become tedious. It is desirable to have a simple, efficient, and intelligent way of managing CU-UPs distributed across the network. Intelligent selection of CU-UP by CU-CP based on certain criteria is desirable.

4G/5G Open RAN CU-UP Pool Solution proposes a simple, efficient and intelligent solution to manage CU-UP in CU-CP. This solution helps in intelligent selection of CU-UP for a particular set of subscribers based on capabilities of CU-UP. It ensures CU-UP with certain capabilities are used for appropriate type of subscribers.

4G/5G Open RAN CU-UP Pool Solution Proposes following solution:

Provides simple, efficient and intelligent solution to manage CU-UP.

Introduces concept of CU-UP Pool in CU-CP.

CU-UP Pool is a group of CU-UPs with similar characteristics meant to cater a particular type of traffic or subscribers. A pool may have an identifier (name or ID), in some embodiments.

CU-UP Pools are configured in CU-CP.

CU-CP associates CU-UP pool with a particular type of subscribers.

CU-CP selects CU-UP pool based on a combination of the following factors: location (physical or network); type of CU-UP (for high speed 5G/4G traffic, for low latency, for special accelerators capability and others); load capacity; 5G support (or other RAT support); CU-UP Redundancy type; or other factors.

CU-CP may perform pool creation at one time or at multiple times. CU-CP may perform pool creation as needed, based on manual intervention, or based on a threshold of attached UEs (devices) or users or sessions, or based on other factors that may be generally understood to affect network traffic and performance, including non-network factors such as weather, time of day and date.

With the solution being proposed the 4G/5G Open RAN CU-UP Pool Solution CU-CP will manage CU-UPs using the concept of CU-UP pools.

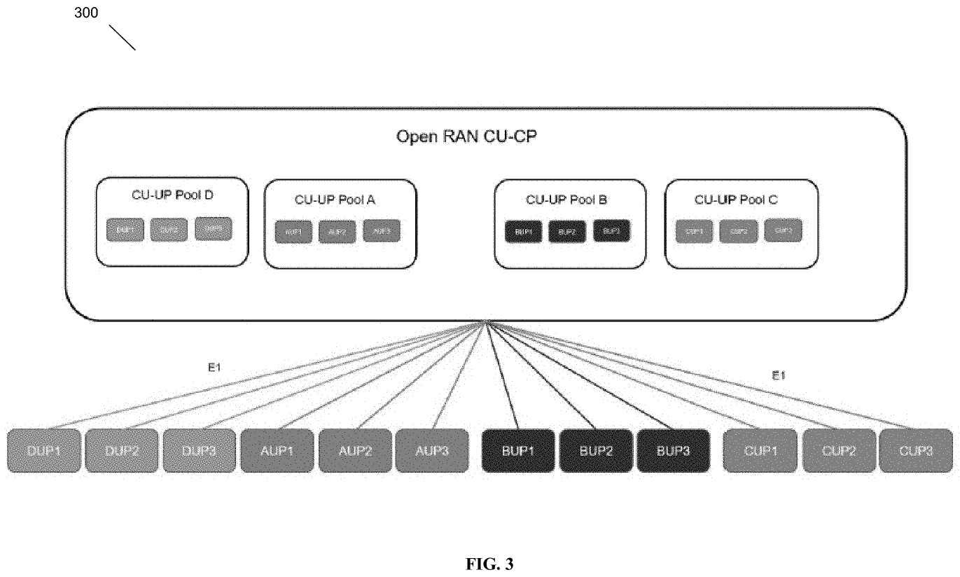

FIG. 3 shows a system 300 wherein CU-UPs are put into a CU-UP pool based on the similar capabilities of the CU-UP. CU-UP Pool is a group of CU-UPs with similar characteristics meant to cater a particular type of traffic or subscribers. CU-UP Pools are configured in CU-CP. CU-CP associates CU-UP pool with a particular type of subscribers. CU-CP selects CU-UP pool based on characteristics known at the time or predicted. In some embodiments, characteristics from other networks, other RATs, or from other layers in the network (including the CU, the DU, the RAN generally, or the core, or based on interaction from the RIC, including via xApps or rApps) may be used to perform pool mapping. In some embodiments, managing the mapping of CU-UP to a Pool may be done manually or by an automatic or algorithmic process to optimize that the CU-UPs in a pool are appropriately utilized. In some embodiments, pool mapping may be performed at the RIC. In some embodiments, pool mapping may be performed based on xApps or rApps at the RIC.

In some embodiments, multiple CU-UPs in a pool may be managed by translating messages intended for a single CU-UP and sending the same or similar messages to each of the CU-UPs in the pool. In some embodiments, management of multiple CU-UPs may be simplified by performing management tasks on all of the CU-UPs in a pool based on a single user-facing operation or based on a single request, e.g., from the RIC or from the core. In some embodiments, the CU-UPs in a pool may each individually respond to the CU-CP and the CU-CP may coalesce messages in any direction so that they appear to come from the pool and not from the individual CU-UPs. In some embodiments, the CU-UPs in a pool may have their actual network addresses hidden from other nodes. In some embodiments, the CU-UP pool mapping may be stored in memory, in a file, in a table, etc. and this information may be kept at the CU-CP or sent to another network node as appropriate.

Solution proposed is beyond standards. Solution proposed has both pros and cons associated with and thus extends the standards as proposed in 3GPP & ORAN.

Advantages of the proposed 4G/5G Open RAN CU-UP Pool Solution are: Provides simple, efficient and intelligent management of CU-UPs in CU-CP; Intelligent selection of CU-UP for a particular set of subscribers based on capabilities of CU-UP; Ensures CU-UP with certain capabilities are used for appropriate type of subscribers; Helps in reserving CU-UPs for certain type of subscribers, and for performing network slicing; Supports location-based CU-UP selection; Supports UP capability-based CU-UP selection; Supports UP load based CU-UP selection. This will help distribute traffic evenly across CU-UP.

Where OpenRAN is discussed herein, it is understood that a variety of implementations and embodiments can be described as meeting the requirements and specifications of OpenRAN (e.g., OpenRAN compliant, OpenRAN specified, etc.), but that the present disclosure presents enhancements and differentiations that are compatible with, in some embodiments, but not the same as a reference implementation of OpenRAN. Specifically, FIG. 2 and FIG. 3 refer to OpenRAN but in the sense that they depict OpenRAN-compliant enhanced embodiments of the present disclosure, and the use of OpenRAN with respect to these figures does not limit the disclosure, nor does such use suggest that the embodiments depicted therein are known in the art.

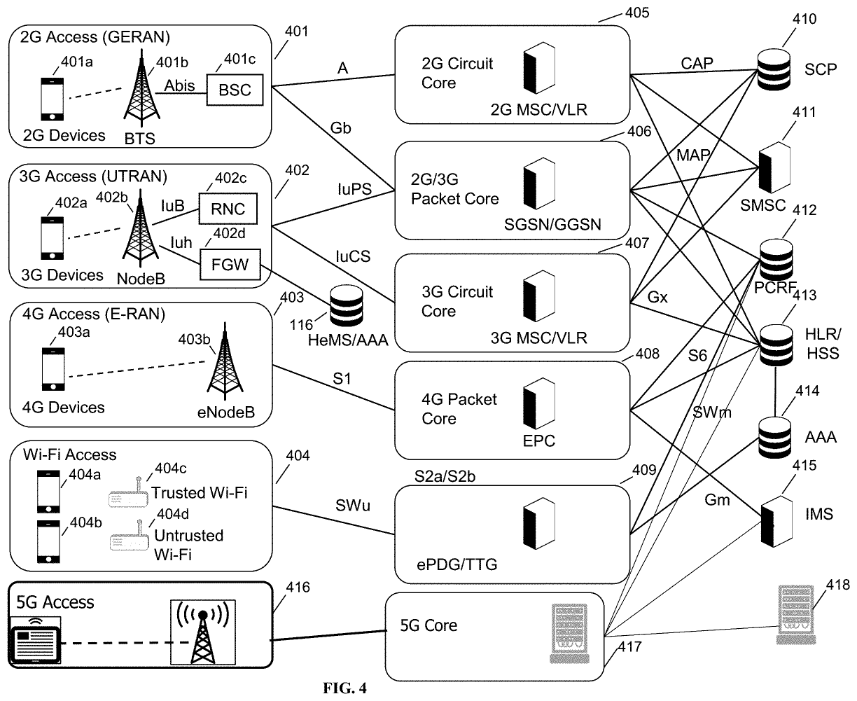

FIG. 4 shows is a schematic network architecture diagram for 3G and other-G prior art networks. The diagram shows a plurality of “Gs,” including 2G, 3G, 4G, 5G and Wi-Fi. 2G is represented by GERAN 101, which includes a 2G device 101a, BTS 401b, and BSC 401c. 3G is represented by UTRAN 402, which includes a 3G UE 402a, nodeB 402b, RNC 402c, and femto gateway (FGW, which in 3GPP namespace is also known as a Home nodeB Gateway or HNBGW) 402d. 4G is represented by EUTRAN or E-RAN 403, which includes an LTE UE 403a and LTE eNodeB 403b. Wi-Fi is represented by Wi-Fi access network 404, which includes a trusted Wi-Fi access point 404c and an untrusted Wi-Fi access point 404d. The Wi-Fi devices 404a and 404b may access either AP 404c or 404d. In the current network architecture, each “G” has a core network. 2G circuit core network 405 includes a 2G MSC/VLR; 2G/3G packet core network 406 includes an SGSN/GGSN (for EDGE or UMTS packet traffic); 3G circuit core 407 includes a 3G MSC/VLR; 4G circuit core 408 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 430, the SMSC 431, PCRF 432, HLR/HSS 433, Authentication, Authorization, and Accounting server (AAA) 434, and IP Multimedia Subsystem (IMS) 435. An HeMS/AAA 436 is present in some cases for use by the 3G UTRAN. The diagram is used to indicate schematically the basic functions of each network as known to one of skill in the art, and is not intended to be exhaustive. For example, 5G core 417 is shown using a single interface to 5G access 416, although in some cases 5G access can be supported using dual connectivity or via a non-standalone deployment architecture.

Noteworthy is that the RANs 401, 402, 403, 404 and 436 rely on specialized core networks 405, 406, 407, 408, 409, 437 but share essential management databases 430, 431, 432, 433, 434, 435, 438. More specifically, for the 2G GERAN, a BSC 401c is required for Abis compatibility with BTS 401b, while for the 3G UTRAN, an RNC 402c is required for Iub compatibility and an FGW 402d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

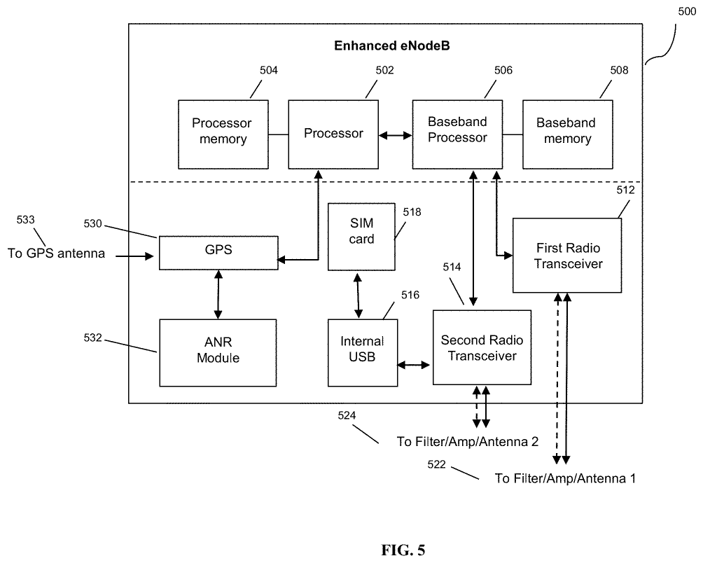

FIG. 5 shows an enhanced eNodeB for performing the methods described herein, in accordance with some embodiments. eNodeB 500 may include processor 502, processor memory 504 in communication with the processor, baseband processor 506, and baseband processor memory 508 in communication with the baseband processor. Mesh network node 500 may also include first radio transceiver 512 and second radio transceiver 514, internal universal serial bus (USB) port 516, and subscriber information module card (SIM card) 518 coupled to USB port 516. In some embodiments, the second radio transceiver 514 itself may be coupled to USB port 516, and communications from the baseband processor may be passed through USB port 516. The second radio transceiver may be used for wirelessly backhauling eNodeB 500.

Processor 502 and baseband processor 506 are in communication with one another. Processor 502 may perform routing functions, and may determine if/when a switch in network configuration is desired. Baseband processor 506 may generate and receive radio signals for both radio transceivers 512 and 514, based on instructions from processor 502. In some embodiments, processors 502 and 506 may be on the same physical logic board. In other embodiments, they may be on separate logic boards.

Processor 502 may identify the appropriate network configuration, and may perform routing of packets from one network interface to another accordingly. Processor 502 may use memory 504, in particular to store a routing table to be used for routing packets. Baseband processor 506 may perform operations to generate the radio frequency signals for transmission or retransmission by both transceivers 510 and 512. Baseband processor 506 may also perform operations to decode signals received by transceivers 512 and 514. Baseband processor 506 may use memory 508 to perform these tasks.

The first radio transceiver 512 may be a radio transceiver capable of providing LTE eNodeB functionality, and may be capable of higher power and multi-channel OFDMA. The second radio transceiver 514 may be a radio transceiver capable of providing LTE UE functionality. Both transceivers 512 and 514 may be capable of receiving and transmitting on one or more LTE bands. In some embodiments, either or both of transceivers 512 and 514 may be capable of providing both LTE eNodeB and LTE UE functionality. Transceiver 512 may be coupled to processor 502 via a Peripheral Component Interconnect-Express (PCI-E) bus, and/or via a daughtercard. As transceiver 514 is for providing LTE UE functionality, in effect emulating a user equipment, it may be connected via the same or different PCI-E bus, or by a USB bus, and may also be coupled to SIM card 518. First transceiver 512 may be coupled to first radio frequency (RF) chain (filter, amplifier, antenna) 522, and second transceiver 514 may be coupled to second RF chain (filter, amplifier, antenna) 524.

SIM card 518 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter used to identify a UE. Special parameters may also be stored in the SIM card or provided by the processor during processing to identify to a target eNodeB that device 500 is not an ordinary UE but instead is a special UE for providing backhaul to device 500.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 512 and 514, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 502 for reconfiguration.

A GPS module 530 may also be included, and may be in communication with a GPS antenna 532 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 532 may also be present and may run on processor 502 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

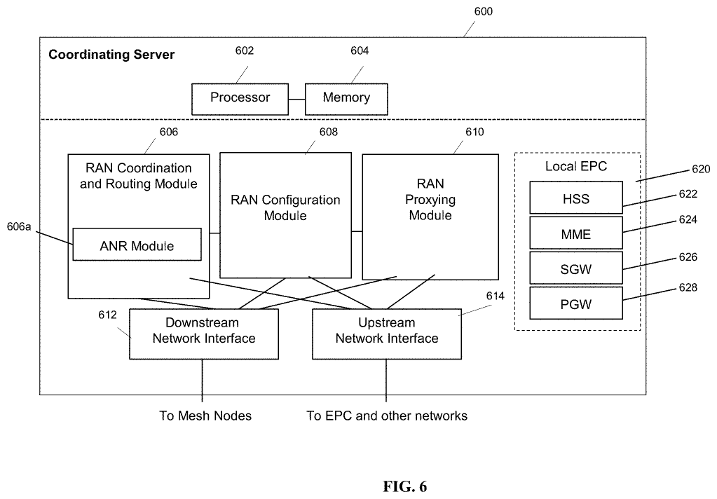

FIG. 6 shows a coordinating server for providing services and performing methods as described herein, in accordance with some embodiments. Coordinating server 600 includes processor 602 and memory 604, which are configured to provide the functions described herein. Also present are radio access network coordination/routing (RAN Coordination and routing) module 606, including ANR module 606a, RAN configuration module 608, and RAN proxying module 610. The ANR module 606a may perform the ANR tracking, PCI disambiguation, ECGI requesting, and GPS coalescing and tracking as described herein, in coordination with RAN coordination module 606 (e.g., for requesting ECGIs, etc.). In some embodiments, coordinating server 600 may coordinate multiple RANs using coordination module 606. In some embodiments, coordination server may also provide proxying, routing virtualization and RAN virtualization, via modules 610 and 608. In some embodiments, a downstream network interface 612 is provided for interfacing with the RANs, which may be a radio interface (e.g., LTE), and an upstream network interface 614 is provided for interfacing with the core network, which may be either a radio interface (e.g., LTE) or a wired interface (e.g., Ethernet).

Coordinator 600 includes local evolved packet core (EPC) module 620, for authenticating users, storing and caching priority profile information, and performing other EPC-dependent functions when no backhaul link is available. Local EPC 620 may include local HSS 622, local MME 624, local SGW 626, and local PGW 628, as well as other modules. Local EPC 620 may incorporate these modules as software modules, processes, or containers. Local EPC 620 may alternatively incorporate these modules as a small number of monolithic software processes. Modules 606, 608, 610 and local EPC 620 may each run on processor 602 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders, as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software used for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of managing Centralized Unit (CU)-User Plane (UP) in CU-Control Plane (CP), the method comprising:
configuring a pool of CU-UPs;
associating a CU-UP of the pool of CU-UPs with a type of subscriber; and
selecting a CU-UP of the pool of CU-UPs pool based on characteristics associated with the CU-UP.

2. The method of claim 1 wherein the configuring a pool of CU-UPs in a CU-CP includes grouping CU-UPs with similar characteristics for a particular type of traffic or subscribers.

3. The method of claim 1 wherein the configuring a pool of CU-UPs occurs in the CU-CP.

4. The method of claim 1 further comprising associating, by the CU-CP, a CU-UP pool with a particular type of subscribers.

5. The method of claim 1 wherein a CU-CP selects a CU-UP pool based on characteristics including location, type of CU-UP, load capacity, 5G support, and CU-UP redundancy type.

6. The method of claim 5 wherein a type of CU-UP includes a type for high speed 5G/4G traffic.

7. The method of claim 5 wherein a type of CU-UP includes a type for low latency.

8. The method of claim 5 wherein a type of CU-UP includes a type for special accelerators capability.

9. A system managing Centralized Unit (CU)-User Plane (UP) in CU-Control Plane (CP), the system comprising:
an Open RAN CU-CP;
a configured pool of CU-UPs in communication with the Open RAN CU-CP;
wherein the CU-UP of the pool of CU-UPs is associated with a type of subscriber; and
wherein a CU-UP of the pool of CU-UPs is selected based on characteristics associated with the CU-UP.

10. The system of claim 9 wherein the configuring a pool of CU-UPs in a CU-CP includes grouping CU-UPs with similar characteristics for a particular type of traffic or subscribers.

11. The system of claim 9 wherein the configuring a pool of CU-UPs occurs in the CU-CP.

12. The system of claim 9 further comprising associating, by the CU-CP, a CU-UP pool with a particular type of subscribers.

13. The system of claim 9 wherein a CU-CP selects a CU-UP pool based on characteristics including location, type of CU-UP, load capacity, 5G support, and CU-UP redundancy type.

14. The system of claim 13 wherein a type of CU-UP includes a type for one of high speed 5G/4G traffic, for low latency, or special accelerators capability.

15. A non-transitory computer-readable medium containing instructions for managing Centralized Unit (CU)-User Plane (UP) in CU-Control Plane (CP), which, when executed, cause the system to perform steps comprising:
configuring a pool of CU-UPs;
associating a CU-UP of the pool of CU-UPs with a type of subscriber; and
selecting a CU-UP of the pool of CU-UPs pool based on characteristics associated with the CU-UP.

16. The non-transitory computer-readable medium of claim 15 wherein the instructions for configuring a pool of CU-UPs in a CU-CP includes instructions for grouping CU-UPs with similar characteristics for a particular type of traffic or subscribers.

17. The non-transitory computer-readable medium of claim 15 further comprising instructions wherein the configuring a pool of CU-UPs occurs in the CU-CP.

18. The non-transitory computer-readable medium of claim 15 further comprising instructions for associating, by the CU-CP, a CU-UP pool with a particular type of subscribers.

19. The non-transitory computer-readable medium of claim 15 further comprising instructions wherein a CU-CP selects a CU-UP pool based on characteristics including location, type of CU-UP, load capacity, 5G support, and CU-UP redundancy type.

20. The non-transitory computer-readable medium of claim 19 further comprising instructions wherein a type of CU-UP includes one of a type for high speed 5G/4G traffic, for low latency. Or for special accelerators capability.
